(19) United States
(12) Patent Application Publication
(10) Pub. No.: US 2009/0024381 A1
(43) Pub. Date: Jan. 22, 2009

(54) Simulation device for co-verifying hardware and software

(75) Inventors: Yoshinori Sakamoto, Kawasaki (JP); Toshiyuki Tanimizu, Kawasaki (JP); Fuyuki Matsubayashi, Kawasaki (JP); Ryo Kuya, Kawasaki (JP); Tatsuya Yoshino, Kawasaki (JP); Hideo Miyake, Kawasaki (JP); Masaharu Kimura, Kawasaki (JP); Yukoh Matsumoto, Tsukuba (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/155,002

(22) Filed: May 28, 2008

(30) Foreign Application Priority Data
Jul. 20, 2007 (JP) 2007-189317

(51) Int. Cl. G06F 9/455

(52) U.S. Cl. 703/26

(57) ABSTRACT

A simulation device capable of verifying coordinated operation of software and hardware faster and more accurately. The simulation device has a framework including a virtual OS and a virtual CPU to execute software under test. The virtual OS and CPU also serve as a first scheduler that manages an execution schedule for the software under test. The framework includes a communication interface for communication between the software under test and hardware models. A second scheduler manages simulation processes of the framework and the hardware model. The virtual OS and CPU release their execution right to the second scheduler according to the execution schedule of the software under test.

### CROSS-REFERENCE TO RELATED APPLICATIONS

This application is based upon and claims the benefits of priority from the prior Japanese Patent Application No. 2007-189317, filed on Jul. 20, 2007, the entire contents of which are incorporated herein by reference.

### BACKGROUND

1. Field

The embodiments discussed herein are directed to simulation devices and programs, which may relate to a simulation device and a simulation program for hardware and software co-verification running on a target processor.

2. Description of the Related Art

Computer systems are formed from hardware and software; software programs run on a hardware platform including one or more processors. The development process of such a system involves the stage of design validation using system-level simulation tools. Specifically, the simulator simulates the behavior of both hardware and software of a system to be verified (referred to hereinafter as a “target system”), so as to test whether each software code running on a target processor really works with hardware components in an intended way. For this purpose, the target system hardware is defined as hardware models written in, for example, a C-based system-level design language.

Software operations can be simulated with one of the following methods: (1) simulating execution of software code by using an instruction set simulator (ISS) that mimics the behavior of a real processor, and (2) directly executing software code by using a central processing unit (CPU) of the simulator itself. Simulators using the former method are referred to herein as “ISS-based simulators,” and those using the latter method “non-ISS-based simulators.”

Conventional ISS-based simulators interpret processor instructions one by one to simulate their operation. Besides requiring memory access operations for each instruction, the simulation process involves frequent transfer of execution rights to the scheduler, thus slowing down the simulation.

Non-ISS-based simulators take actual software processing times into consideration in an attempt to make simulation results more accurate. One type of non-ISS-based simulators achieve this by identifying blocks containing software components, inserting control points, and adding statements indicating the time between control points. Another type of non-ISS-based simulators achieve the same by inserting control points into a source program at certain intervals and adding statements indicating the time between control points. See, for example, Japanese Unexamined Patent Publication Nos. 2006-023852, 2005-293219, and 2004-234528. See also the magazine article titled “STARC's SystemC-based Technique for High-speed Co-verification of Hardware and Software” (original in Japanese), Nikkei Micro Device (Japan), January 2005, pages 106-107.

### SUMMARY

In view of the foregoing, it is an object of the present invention to provide a simulation device and a simulation program that can verify coordinated operation of software and hardware faster and more accurately.

To accomplish the above object, the present invention provides a simulator for hardware and software co-verification running on a target processor. This simulator includes, among others, (a) a framework including a first scheduler managing a first execution schedule for software under test, and a communication channel between the software under test and a hardware model describing hardware in a system-level design language; and (b) a second scheduler managing a second execution schedule for the framework and the hardware model. The framework further includes an execution right manager that releases an execution right to the second scheduler in accordance with the first execution schedule for the software under test.

Also to accomplish the above object, the present invention provides another simulation device for software and hardware co-verification subsystems on a target processor. This simulation device includes, among others, a scheduler managing an execution schedule for software under test and a hardware model describing hardware in a system-level design language, and a timer calculating a processing time of the software under test, based on a processing time that the simulation device has consumed to execute the software under test. The scheduler delays starting a next simulation process, based on the calculated processing time.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 gives an overview of a simulator according to a first embodiment of the present invention.

FIG. 2 gives an overview of a simulator according to a second embodiment of the present invention.

FIG. 3 shows a specific hardware configuration of a simulator.

FIG. 4 shows a specific example of software structure of a simulator.

FIG. 5 is a sequence diagram showing task switching operations.

FIG. 6 is a sequence diagram showing a synchronous access from software under test to a hardware model.

FIG. 7 is a sequence diagram showing an asynchronous access from software under test to a hardware model.

FIG. 8 is a sequence diagram showing how the proposed simulator works when its timer is disabled.

FIG. 9 is a sequence diagram showing how the proposed simulator works when its timer is enabled.

### DESCRIPTION OF THE PREFERRED EMBODIMENTS

Some non-ISS based simulators incorporate hardware access functions into software programs to release execution rights to the scheduler. See, for example, Japanese Unexamined Patent Publication No. 2005-18623.

One drawback of such conventional non-ISS-based simulators is their longer simulation time due to frequent transfer of execution rights as a result of hardware access function calls issued from software programs. This drawback stems from their simulation mechanism that allows software programs and hardware models to release their execution right directly to the scheduler during a communication process, for example. Another drawback of conventional non-ISS-based simulators is that the simulation speed and accuracy are inflexibly determined by the description of software and hardware models under test.

In addition to the above, the performance of non-ISS-based simulators may be degraded by the additional time control statements inserted to indicate the time between control points. Actually, a time control statement, e.g., wait( ), has to be inserted between every ten lines or so of the C-language source code. Those time control statements will slow down the simulation processing.

Furthermore, conventional simulators require some modification of software programs for the purpose of simulation. Some cases require porting of software to another operating system, which is particularly time-consuming.

Preferred embodiments of the present invention will now be described in detail below with reference to the accompanying drawings, wherein like reference numerals refer to like elements throughout.

### First Embodiment

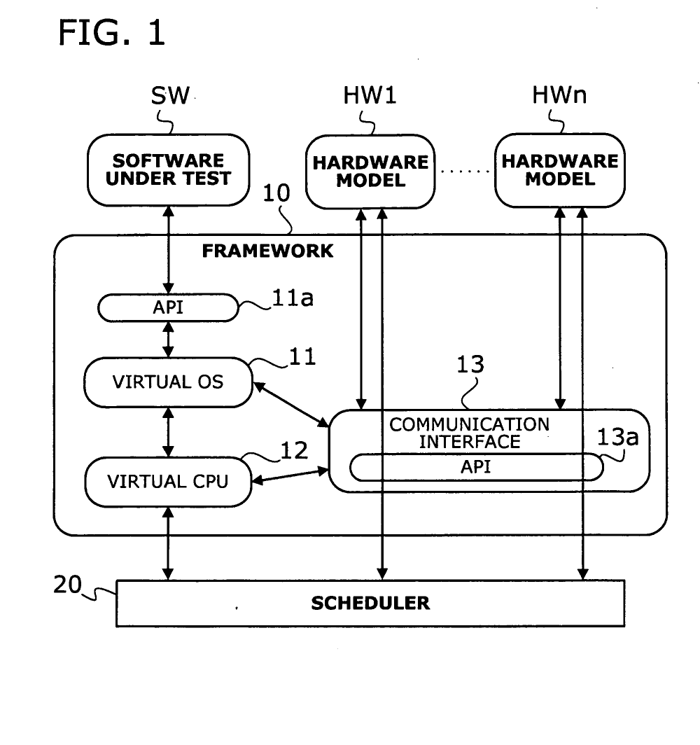

FIG. 1 gives an overview of a simulator according to a first embodiment of the present invention. This simulator is designed to verify coordinated operation of hardware and software running on a target processor. The simulator includes a framework 10 which is formed from a virtual operating system (virtual OS) 11, a virtual central processing unit (virtual CPU) 12, and a communication interface 13. The simulator also includes a scheduler 20. All those components are implemented as software modules written in a C-based language such as SystemC.

Hardware models HW1 to HWn describe the target system's hardware by using SystemC or the like. The virtual OS 11 simulates a specific operating system that the target processor is supposed to use. Specifically, the virtual OS 11, together with the virtual CPU 12, offers the function of scheduling execution of software SW under test. The virtual OS 11 communicates with the software SW under test through an application programming interface (API) 11a provided by the framework 10. This API 11a may be changed, as necessary, in accordance with the requirements of the target system. Suppose, for example, that it is necessary to change the OS of the target system. This change can be implemented by replacing the current API 11a with a new API designed for the new target system OS, without the need for modifying the software SW under test.

The virtual CPU 12 simulates the target processor by mimicking the behavior of its CPU. The virtual CPU 12 has the capability of handling interrupts. The virtual CPU 12 also cooperates with the virtual OS 11 to control transfer of execution rights to the scheduler 20 according to an execution schedule of the software SW under test. For example, the virtual CPU 12 releases an execution right to scheduler 20 to start the next scheduled simulation process (e.g., process with a hardware model HW) when the virtual CPU 12 has finished all executable application tasks available at a particular time point on the simulation time axis.

The communication interface 13 simulates communication channels of the target system. Specifically, the communication interface 13 allows the software SW under test to interact with hardware models HW1 to HWn through an API 13a. The communication interface 13 also supports communication between hardware models HW1 to HWn. In addition to the above, the communication interface 13 controls the abstraction levels of communication between software SW under test and hardware models HW1 to HWn, as well as between hardware model HW1 to HWn. For example, in the case of giving priority to simulation speeds, the communication interface 13 chooses a transaction-level abstraction model. In the case of giving priority to simulation accuracy, the communication interface 13 switches it to a bus-cycle accurate model of abstraction.

The scheduler 20 manages an execution schedule of the framework 10 and hardware models HW1 to HWn. Specifically, the scheduler 20 performs event-driven scheduling (also known as timing-driven scheduling) to evaluate the hardware models HW1 to HWn and virtual CPU 12 executing the software SW under test and other tasks.

Some classes of software code do not use OS functions. If this is the case, the virtual CPU 12 controls verification of such software without using the virtual OS 11 in the framework 10.

According to the arrangement described above, the software SW is executed under the control of the virtual CPU 12 in the framework 10, according to an execution schedule that the virtual OS 11 manages. The execution right is released back to the scheduler 20 according to the execution schedule of the virtual OS 11, also under the control of the virtual CPU 12. Tasks of hardware models HW1 to HWn can then be executed according to an execution schedule that the scheduler 20 manages. In this way, the simulator according to the first embodiment verifies coordinated operations of the software SW under test and hardware models HW1 to HWn, without the need for modifying the software SW under test. The proposed simulator greatly reduces the frequency of releasing execution rights, which has been a problem for conventional simulators using time control statements to specify when to release execution rights. The present embodiment thus speeds up the simulation.

The simulation speed of typical ISS-based software-hardware co-simulators is 1000 times as slow as the actual operating speed of a target system. Non-ISS-based simulators run faster, but still take 10 to 100 times longer because of the overhead of time control statements. However, the above-described framework 10 makes it possible to perform a simulation at speeds comparable to the target system or even at a higher speed, depending on the performance of the simulator's CPU.

Since the communication interface 13 controls abstraction levels of communication functions, the proposed simulator can run a simulation at a desired speed and accuracy depending on the purpose, without the need for modifying software SW under test or hardware models HW1 to HWn.

Moreover, the foregoing API 11a in the framework 10 absorbs the difference between operating systems. Software SW can therefore be tested without the need for porting it to a different OS.

The first embodiment shown in FIG. 1 includes a scheduler 20 as an independent component. The present invention, however, is not limited to this specific design. For example, the scheduler 20 may be implemented as an integral part of the framework 10.

### Second Embodiment

The first embodiment described in the previous section is directed to untimed simulation which disregards the timing aspects of software programs. This section will now describe a second embodiment of the present invention, which enables timed simulation of software SW under test without the need for modifying it.

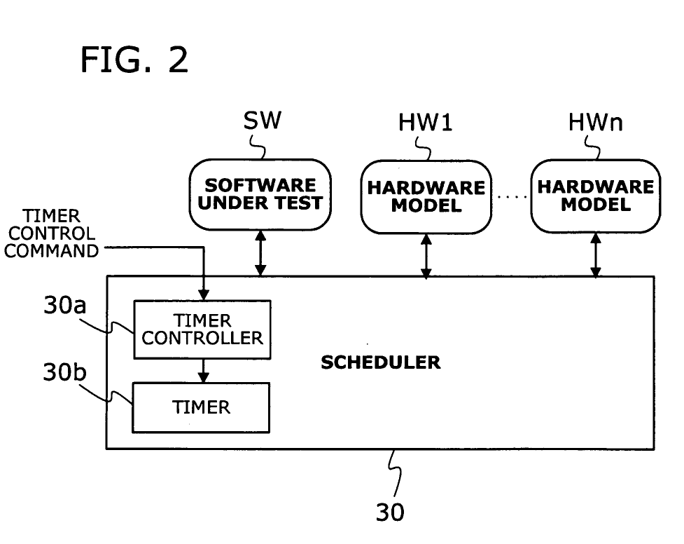

FIG. 2 gives an overview of a simulator according to the second embodiment of the present invention. As FIG. 2 illustrates, this simulator has a scheduler 30 including a timer controller 30a and a timer 30b. The scheduler 30 manages an execution schedule for software SW under test and hardware models HW1 to HWn on an event-driven basis. The timer controller 30a enables or disables the timer 30b in response to timer control commands given from an external source (e.g., user). The timer 30b calculates a processing time of the software SW under test from a processing time that the simulator actually consumes on its platform (e.g., personal computer). More specifically, the target processor and the simulator's own processor (hereafter “host CPU”) are different in their performance. The timer 30b estimates a processing time of the software SW under test, based on the performance difference between the two processors.

When the timer 30b is enabled, the scheduler 30 delays starting the next simulation process, bases on the processing time of the software SW under test that the timer 30b provides. The scheduler 30 also watches the timer output to determine whether a new event time is reached. Upon detection of such an event, the scheduler 30 stops execution of the software SW under test and starts a scheduled simulation process of a hardware model HW1 to HWn.

In the case where no timer functions are required, the timer controller 30a deactivates the timer 30b according to a timer control command from an external source. The current task of the software SW under test continues to run until it enters to a wait state.

With the above-described timer 30b, the simulator according to the second embodiment can simulate the behavior of a target system with a high accuracy, taking into consideration the processing time of each software task, without the need for inserting time control statements to the software SW under test. When evaluating the performance of the target system, the user may enable the timer 30b for accurate simulation. The user may, in turn, disable the timer 30b to speed up the simulation when he/she focuses on functional verification. In this way, the second embodiment of the present invention allows the user to choose between speed and accuracy, depending on the purpose.

While the scheduler 30 of FIG. 2 contains a timer controller 30a and a timer 30b, it is also possible to implement them as independent components outside the scheduler 30. If this is the case, the timer 30b supplies its values to the scheduler 30. The next and subsequent sections will provide more details of the simulators according to the first and second embodiments.

### Hardware Platform for Simulator

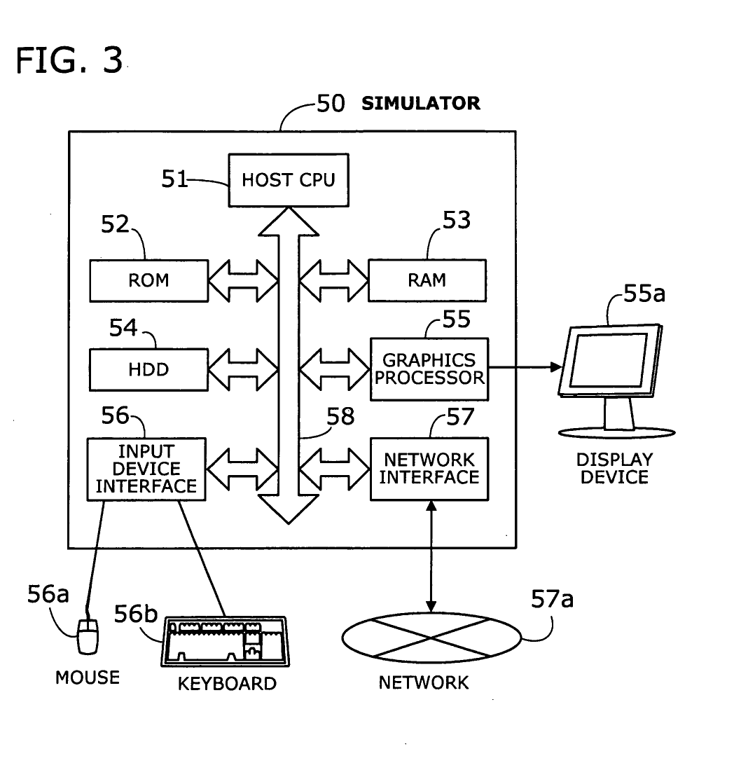

FIG. 3 shows a specific hardware configuration of a simulator. This simulator 50 is based on a personal computer, for example, which is formed from the following components: a host CPU 51, a read only memory (ROM) 52, a random access memory (RAM) 53, a hard disk drive (HDD) 54, a graphics processor 55, an input device interface 56, and a network interface 57. Those components interact with each other via a bus 58.

The host CPU 51 controls other hardware components according to programs and data stored in the ROM 52 and HDD 54, so as to realize the functions of the framework 10 and scheduler 20 discussed earlier in FIG. 1. The ROM 52 stores basic programs and data that the host CPU 51 executes and manipulates. The RAM 53 serves as temporary storage for programs and scratchpad data that the host CPU 51 executes and manipulates at runtime. The HDD 54 stores programs to be executed by the host CPU 51, which include: operating system programs (e.g., Windows (registered trademark of Microsoft Corporation)) and simulation programs. Also stored are files of software SW under test, hardware models HW1 to HWn, and the like.

The graphics processor 55 produces video images representing simulation results or the like in accordance with drawing commands from the host CPU 51 and displays them on the screen of a display device 55a coupled thereto. The input device interface 56 receives user inputs from input devices such as a mouse 56a and a keyboard 56b and supplies them to the host CPU 51 via the bus 58. The network interface 57 is connected to a network 57a, allowing the host CPU 51 to communicate with other computers (not shown). The network 57a may be an enterprise local area network (LAN) or a wide area network (WAN) such as the Internet.

### Software Structure of Simulator

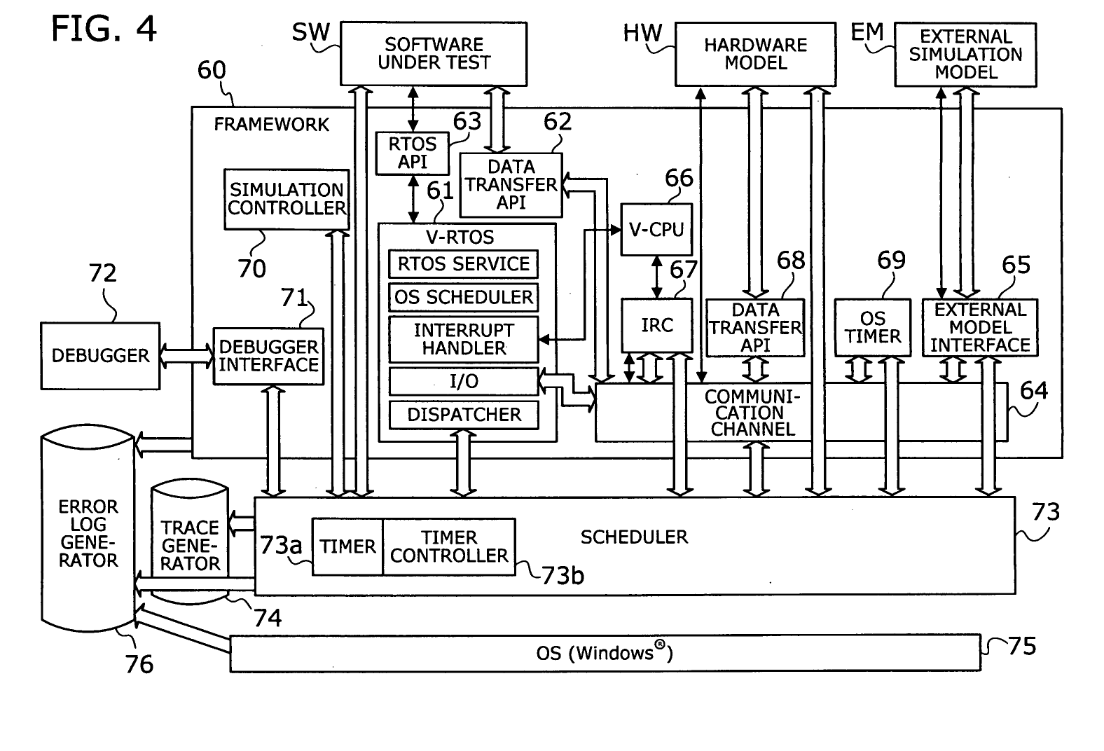

The hardware platform shown in FIG. 3 is used to realize a simulator with software components described below. FIG. 4 shows a specific example of software structure of a simulator according to the present invention, which provides both untimed and timed simulator functions described earlier in FIGS. 1 and 2. In FIG. 4, the black arrows indicate inter-event communication while the white arrows show other signal and data flows.

Software SW under test is an embedded software program designed to run on a target system. More specifically, this software SW may be an application task, an interrupt service routine (ISR), or a device driver written in a C-based language. Such software SW is tested together with a hardware model HW representing hardware functions of the target system. The hardware model HW contains a transaction-level model of each hardware component, test benches, and other entities described in SystemC or other language. Operation timings are defined, based on time and accuracy estimation in the modeling phase. While FIG. 4 shows only one hardware model HW for simplicity purposes, two or more such hardware models may be subjected to the simulation as shown in FIGS. 1 and 2.

The simulator includes a framework 60 formed from the following elements: a virtual realtime operating system (V-RTOS) 61, a data transfer API 62, an RTOS API 63, a communication channel 64, an external model interface 65, a virtual CPU (V-CPU) 66, an interrupt controller (IRC) 67, a data transfer API 68, an OS timer 69, a simulation controller 70, and a debugger interface 71.

The V-RTOS 61 is a simulation model of an RTOS that the target processor uses, which corresponds to the virtual OS 11 discussed earlier in FIG. 1. In addition to offering RTOS services, the V-RTOS 61 provides scheduling functions for execution of software SW under test, interrupt handler functions, I/O functions, and task dispatcher functions. FIG. 4 shows the execution scheduling functions as “OS scheduler.”

The data transfer API 62 is an API allowing the software SW under test to exchange data with the hardware model HW. The RTOS API 63 is an API allowing the software SW under test to communicate with the V-RTOS 61. The user may customize the RTOS API 63 according to API of RTOS on the target system.

The communication channel 64 delivers data between the software SW under test and hardware model HW, or between a plurality of hardware models. More specifically, the communication channel 64 offers transaction-level communication functions (e.g., data communication, interrupt request and response), with a selection of point-to-point or bus functional model (BFM). The abstraction level of communication functions may be changed, as mentioned earlier. For example, it is possible to prioritize simulation speed over simulation accuracy, or vice versa.

The external model interface 65 is an interface for an external simulation model EM which mimics the environment surrounding the target system. Specifically, an external model may be prepared as a dynamic link library (DLL) or an additional framework similar to the framework 60.

The V-CPU 66 is a virtual CPU model of the target processor, which performs interrupt processing and other tasks. The V-CPU 66 corresponds to the virtual CPU 12 discussed earlier in FIG. 1. While FIG. 4 shows only one V-CPU 66, the framework 60 may include two or more such V-CPUs to simulate a multi-processor system. The IRC 67 informs the V-CPU 66 of an interrupt event from the hardware model HW. The IRC 67 clears that interrupt event upon receipt of an acknowledgment from the V-CPU 66.

The data transfer API 68 is an API allowing one hardware model HW to exchange data with the software SW under test or with other hardware models HW, if any. The OS timer 69 is a model representing timer functions used for time management of RTOS in the target system.

The simulation controller 70 controls (e.g., start and stop) a simulation process according to user inputs. The debugger interface 71 is used to connect the framework 60 with an external debugger 72. The framework 60 supplies all necessary debugging information to the debugger 72 via this debugger interface 71.

The framework 60 of the present embodiment includes the above functions, which are written in a C-based language such as SystemC. The simulator shown in FIG. 4 further includes the following components outside the framework 60: a debugger 72, a scheduler 73, a trace generator 74, an operating system (OS) 75, and an error log generator 76.

The debugger 72 is a software debugger such as MULTI (trademark of Green Hills Software, Inc., US) and VC++ (registered trademark of Microsoft Corporation, US). The debugger 72 communicates with the framework 60 through a debugger interface 71 as mentioned above. A graphical user interface (GUI) may be employed to present the results of debugging on a screen of the display device 55a (FIG. 3).

The scheduler 73 performs event-driven scheduling to define the times at which the framework 60 and hardware model HW are to be evaluated. The scheduler 73 includes a timer 73a and a timer controller 73b. The timer 73a calculates a processing time of the software SW under test, based on the time consumed on the simulator. More specifically, the timer 73a estimates a processing time that the software SW under test would take on the target processor, taking into consideration the performance difference between the target processor and the simulator's host CPU 51 (FIG. 3).

The timer controller 73b enables or disables the timer 73a in response to timer control commands given from the user, for example. Specifically, the timer 73a is enabled when accuracy has a higher priority than speed as in the case of functional verification. The timer 73a is disabled when simulation speed is more important than accuracy.

The trace generator 74 outputs trace records of various events. Specifically, RTOS operation trace includes log records of V-RTOS and embedded software, besides showing interrupt operations. Communication event trace is a log of communication events such as calls for RTOS API 63, data transfer operations, and interrupts. Hardware event trace is an operation log of each hardware component of the hardware model HW, including I/O access operations. GUI allows those trace records to be presented on a screen of the display device 55a (FIG. 3).

The OS 75 refers to the operating system of the simulator, which may be, for example, the Windows operating system from Microsoft Corporation.

The error log generator 76 outputs log records of various errors. Specifically, framework errors include improper settings, restriction violation, and other errors detected in the framework 60. V-RTOS errors include API argument errors, restriction violation, and other errors detected in the V-RTOS 61. Communication errors include protocol violation, resource overflow, API argument error, restriction violation, and other errors detected in communication operations. Hardware model errors include protocol violation, resource overflow, restriction violation, and other errors detected in the hardware model HW. External model interface errors are communication errors detected at the external model interface 65. Debugger errors are errors detected during communication with the debugger 72 (e.g., MULTI, VC++). SystemC simulator errors include exceptions detected in SystemC simulator. Platform errors include exceptions detected in the Windows operating system. GUI allows those error log records to be presented on a screen of the display device 55a (FIG. 3)

The proposed simulator of FIG. 4 is formed from the above-described components, some of which can be customized according to requirements of the target system. The RTOS API 63, IRC 67, and OS timer 69 are among those customizable components of the framework 60.

### Simulator Operation

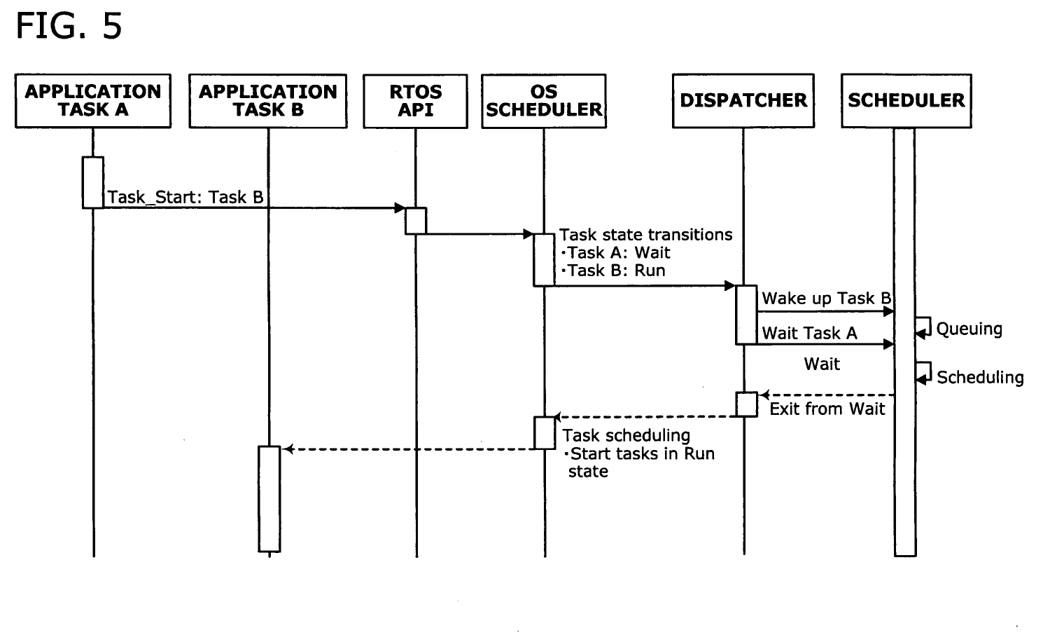

This section will describe how the proposed simulator operates. Referring first to the sequence diagram of FIG. 5, the simulator switches tasks of software SW under test.

FIG. 5 illustrates a task switching operation from one application task (“task A”) to another application task (“task B”). It is assumed that task A is currently running, and it calls Task_Start service of the RTOS API 63 in an attempt to activate task B. This service call triggers the OS scheduler in the framework 60 through the RTOS API 63. The OS scheduler then calls the dispatcher, while putting task A in wait state and task B in run state. The dispatcher issues a command “Wakeup Task B” to request the scheduler 73 to start task B. In response to this command, the scheduler 73 puts task B into a queue of pending simulation processes.

The dispatcher also issues another command “Wait Task A” to request the scheduler 73 to stop execution of task A. In response to this command, the scheduler 73 stops task A and performs scheduling to determine what simulation process to execute next. This scheduling may result in a simulation process of some other hardware model HW, depending on the circumstances. Otherwise, the scheduler 73 selects task B in the queue, which allows the dispatcher to exit from wait. The OS scheduler then determines which pending task should be executed by the V-RTOS 61 in the framework 60. With the absence of interrupts from the hardware model HW, the OS scheduler activates task B according to the task state determined previously (i.e., task A: Wait; task B: Run).

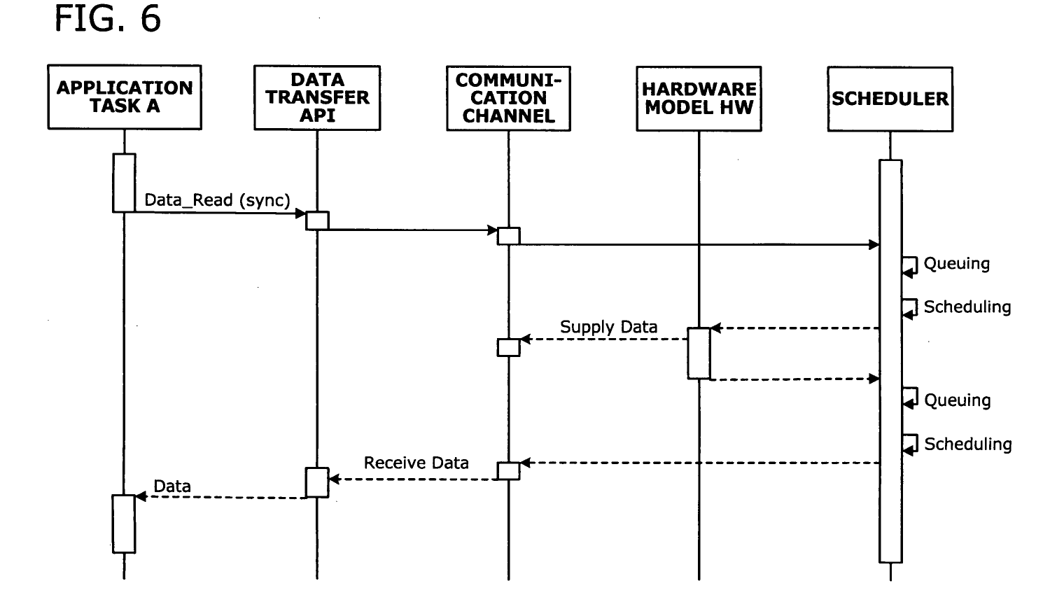

Referring next to the sequence diagram of FIG. 6, the following will describe how the software under test will make synchronous access to hardware models HW. Specifically, FIG. 6 shows a synchronous access operation from task A of the software SW under test to a hardware model HW. Suppose now that the currently running task A calls Data_Read (sync) service of the data transfer API 62 in an attempt to read data from a specific hardware model HW. This service call triggers the communication channel 64 in the framework 60 through the data transfer API 62. Via the scheduler 73, the communication channel 64 informs the hardware model HW of the Data_Read event.

The scheduler 73 puts the event into a queue of simulation processes and determines which simulation process to execute next. In the case where there are two or more hardware models HW, the scheduler 73 may give precedence to other hardware model HW, depending on the circumstances. Otherwise, the scheduler 73 selects the hardware model HW specified in the earlier Data_Read request, thus triggering a data read function of that hardware model HW. As a result, the specified hardware model HW supplies requested data to the communication channel 64.

Upon completion of the above processing, the scheduler 73 performs queuing and scheduling, as necessary, to determine which simulation process to execute next. As a result, task A in the queue is selected, thus permitting the communication channel 64 to transfer the read data to the requesting task A through the data transfer API 62.

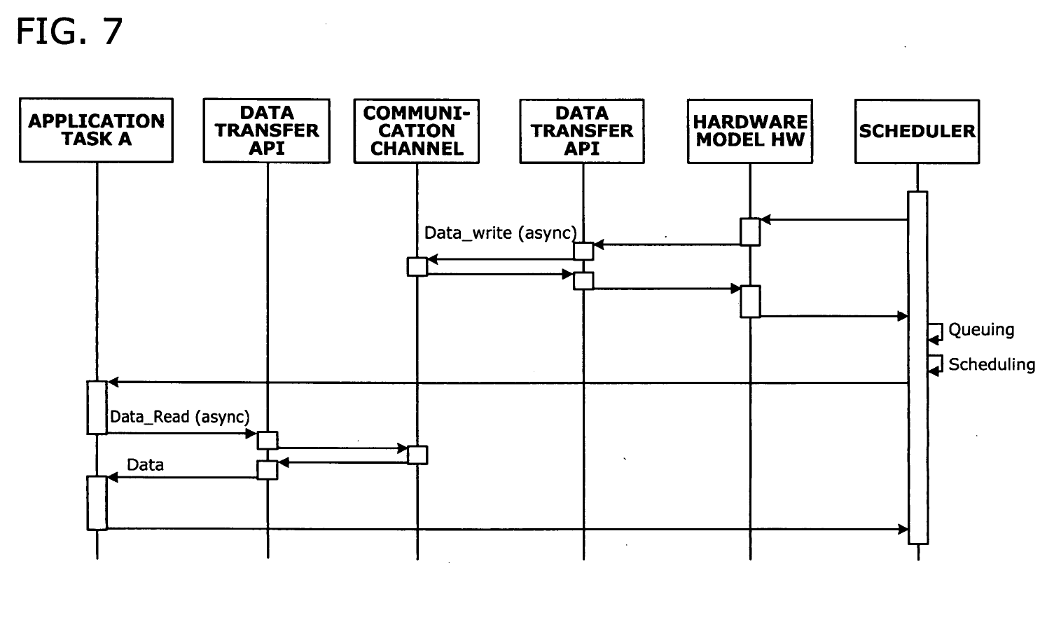

Referring next to the sequence diagram of FIG. 7, the following will describe how the software SW under test will make asynchronous access to hardware models HW. Specifically, FIG. 7 shows an asynchronous access operation from task A of the software SW under test to a specific hardware model HW.

Suppose now that the currently running hardware model HW calls Data_Write (async) service of the data transfer API 68 in an attempt to write some data. This service call triggers the communication channel 64 in the framework 60 through the data transfer API 68. The communication channel 64 stores the write data locally.

Upon completion of the current simulation process of the hardware model HW, the scheduler 73 performs scheduling to determine which simulation process to execute next. This scheduling may result in execution of some other hardware model HW, depending on the circumstances. Otherwise, the scheduler 73 selects task A in the queue, meaning that the execution of task A resumes. Task A includes a data read function, Data_Read (async), in the data transfer API 62, which fetches the stored data from the communication channel 64.

### Timer Functions

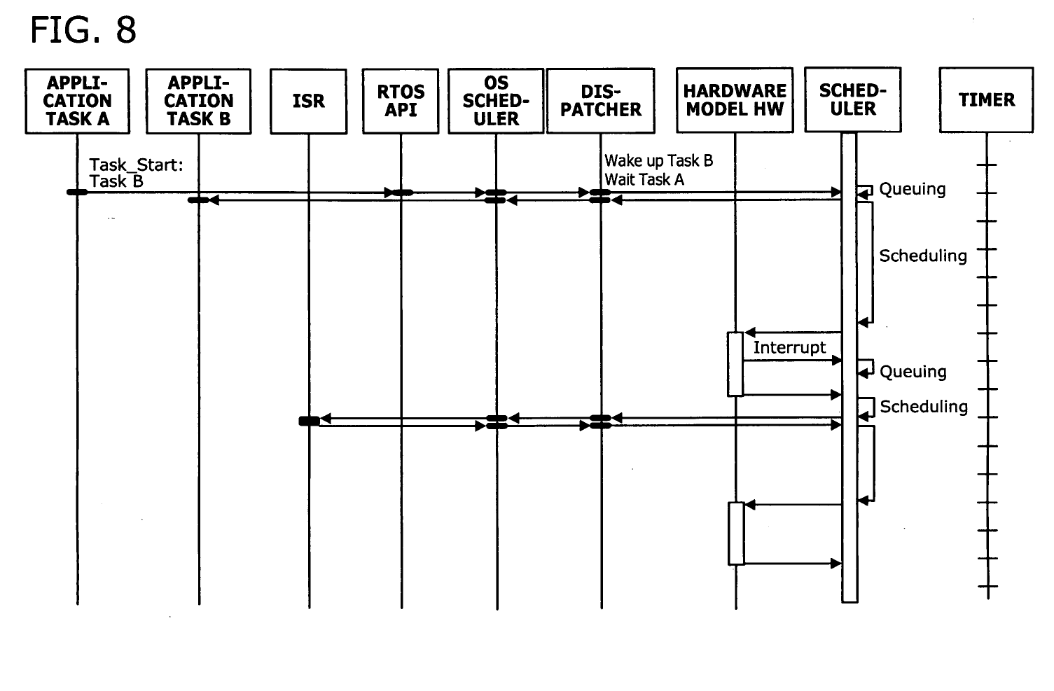

This section will describe the functions of a timer employed in the proposed simulator. As mentioned earlier, the timer functions may be enabled or disabled by, for example, a user input. The sequence diagram of FIG. 8 shows the case where the timer is disabled. It is assumed here that a task switching operation between tasks A and B has taken place in the way discussed earlier in FIG. 5.

The scheduler 73 assumes no delays, in terms of simulation time, for execution of tasks A and B of software SW under test. Accordingly, all software tasks available for execution at a specific point on the simulation time axis are simulated altogether, and control is returned to the scheduler 73 upon completion of those tasks.

The scheduler 73 then advances to the next simulation time point, based on an event time schedule. In the example of FIG. 8, a simulation process for a hardware model HW is executed, and during that process an interrupt event arises. The scheduler 73 puts this interrupt event into a queue.

Upon completion of the simulation process for the hardware model HW, the scheduler 73 advances to the next simulation time point, based on the event time schedule. In the example of FIG. 8, the queued interrupt event invokes a simulation process for ISR. Upon completion of this ISR, the scheduler 73 regains control and advances its position to the next simulation time point according to the event time schedule. In the example of FIG. 8, the scheduler 73 invokes another simulation process of the hardware model HW.

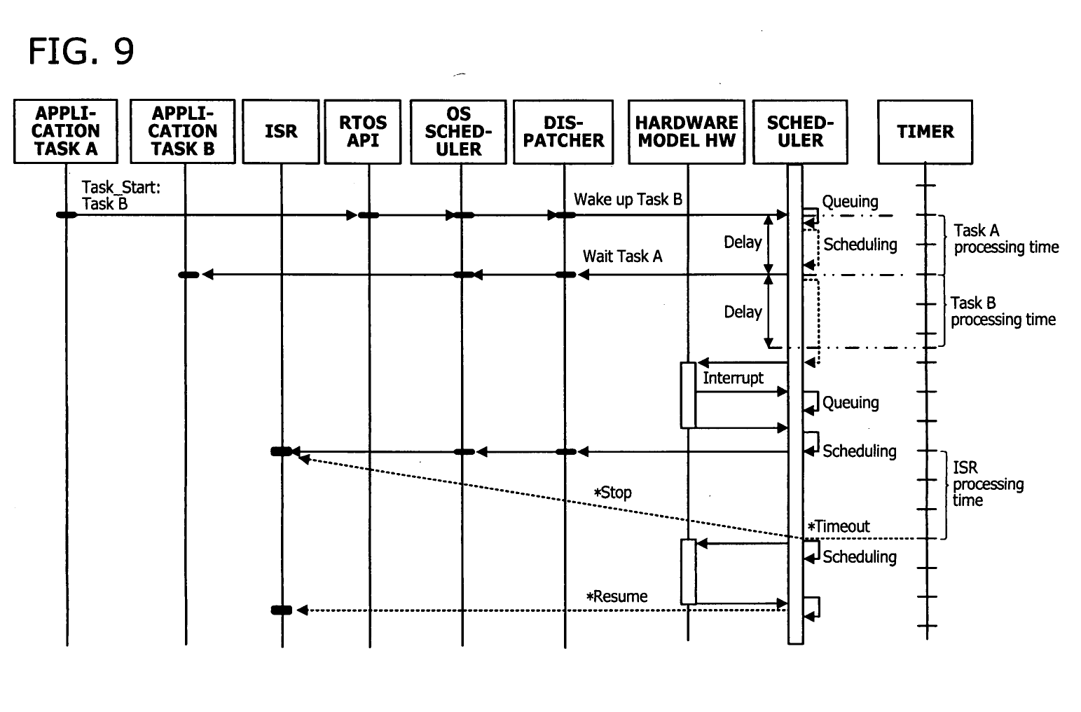

Referring now to the sequence diagram of FIG. 9, the following will describe how the simulator operates in the case where the timer is enabled.

As mentioned before, the scheduler 73 assumes no delays, in terms of simulation time, for execution of tasks A and B of the software SW under test. However, since the timer 73a is enabled, the processing time of each task of the software SW under test is calculated in terms of simulation time, based on the performance difference between the target processor and the simulator's host CPU 51. Accordingly, each time a software simulation of a specific task is completed, the scheduler 73 advances its position on the simulation time axis by the calculated processing time as a delay time of that task.

Referring to the example of FIG. 9, the simulator first executes a simulation process for task A. Upon completion of task A, the scheduler 73 advances its position on the simulation time axis by a delay time corresponding to the software processing time of task A. Then, at this new simulation time point, the scheduler 73 invokes the next scheduled simulation process, which is specifically a simulation process for task B in the example of FIG. 9. When the simulation process of task B is finished, the scheduler 73 advances its position on the simulation time axis by a delay time corresponding to the software processing time of task B. Then at the new time point, the scheduler 73 determines which simulation process to execute next, based on the schedule. In the example of FIG. 9, the scheduler 73 invokes a simulation process for the hardware model HW, and encounters an interrupt during the course of that process. The scheduler 73 then puts this interrupt event into a queue.

Upon completion of the simulation process for the hardware model HW, the scheduler 73 advances to the next simulation time point, based on the event time schedule. In the present example, the scheduler 73 invokes a simulation process for ISR as a response to the interrupt event. During this simulation process, the scheduler 73 receives a timeout signal from the timer 73a, which indicates that the next event time is reached. In responses to the timeout signal, the scheduler 73 stops the ongoing ISR simulation process. The scheduler 73 determines which simulation process is scheduled at the current simulation time point. In the example of FIG. 9, the scheduler 73 invokes another simulation process for the hardware model HW. Then, upon completion of that process, the scheduler 73 resumes the suspended ISR simulation process.

The above-described timer functions permit the simulator to run a simulation with a high accuracy since the software processing time of each task is taken into consideration. This advantage can be achieved without the need for modifying software SW under test to insert time control statements.

### Conclusion

The above discussions are summarized below. According to one aspect of the present invention, the simulator employs a framework with the function of scheduling execution of software under test, along with a scheduler that manages execution schedule for the framework and hardware models. This architecture permits a co-simulation of hardware and software with less frequent transfer of execution rights to the scheduler. The proposed simulator runs fast because it does not use ISS. The proposed simulator require no modification to software under test, including porting to a different operating system.

According to another aspect of the present invention, the simulator has a timer to calculate a processing time of each software task and uses the calculated processing time to determine when to start the next scheduled simulation process. This architecture improves the accuracy of simulation, without the need for inserting time control statements to the software under test.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A simulation device for co-verifying hardware and software running on a target processor, the simulation device comprising:
a) a framework comprising:
a first scheduler managing a first execution schedule for software under test, and
a communication channel between the software under test and a hardware model describing hardware in a system-level design language; and
b) a second scheduler managing a second execution schedule for the framework and the hardware model;
wherein the framework further comprises an execution right manager that releases an execution right to the second scheduler in accordance with the first execution schedule for the software under test.

2. The simulation device according to claim 1, wherein:
the first scheduler or the execution right manager is implemented as a coordinated operation of a virtual CPU mimicking the target processor and a virtual operating system mimicking an operating system used by the target processor; and
the virtual CPU releases an execution right thereof to the second scheduler.

3. The simulation device according to claim 2, wherein the framework further comprises:
a first API for communication between the software under test and the virtual operating system; and
a second API for communication between the software under test and the hardware model.

4. The simulation device according to claim 1, wherein the communication interface changes abstraction levels of communication, depending on whether to give a higher priority to simulation speed or to simulation accuracy.

5. The simulation device according to claim 1, wherein the second scheduler manages the second execution schedule on an event-driven basis to define when to evaluate the framework and hardware model.

6. A simulation device for co-verifying hardware and software running on a target processor, the simulation device comprising:
a scheduler managing an execution schedule for software under test and a hardware model describing hardware in a system-level design language; and
a timer calculating a processing time of the software under test, based on a processing time that the simulation device has consumed to execute the software under test;
wherein the scheduler delays starting a next simulation process, based on the calculated processing time.

7. The simulation device according to claim 6, further comprising a processor, wherein the timer calculates the processing time of the software under test, taking into consideration a performance difference between the target processor and the processor of the simulation device.

8. The simulation device according to claim 6, wherein:
the scheduler manages the execution schedule on an event-driven basis to define when to evaluate the hardware model;
during execution of the software under test, the scheduler consults the timer to determine whether a next event time is reached; and
when the next event time is reached, the scheduler stops the execution of the software under test and invokes another scheduled simulation process.

9. The simulation device according to claim 6, further comprising a timer controller that enables or disables the timer according to a control command that is given.

10. A computer-readable medium a computer-executable program for co-verifying hardware and software running on a target processor, the computer-executable program causing a computer to function as a system comprising:
a) a framework comprising:
a first scheduler managing a first execution schedule for software under test, and
a communication channel between the software under test and a hardware model describing hardware in a system-level design language; and
b) a second scheduler managing a second execution schedule for the framework and the hardware model;
wherein the framework further comprises an execution right manager that releases an execution right to the second scheduler in accordance with the first execution schedule for the software under test.
